(19) United States
(12) Patent Application Publication
(10) Pub. No.: US 2010/0171948 A1
(43) Pub. Date: Jul. 8, 2010

(54) METALIZED SEMICONDUCTOR SUBSTRATES FOR RAMAN SPECTROSCOPY

(75) Inventors: Eric Mazur, Concord, MA (US); Eric Diebold, Boston, MA (US); Steven Ebstein, Newton, MA (US)

Correspondence Address: NUTTER MCCLENNEN & FISH LLP, SEAPORT WEST, 155 SEAPORT BOULEVARD, BOSTON, MA, 02210-2604, US

(73) Assignee: PRESIDENT AND FELLOWS OF HARVARD COLLEGE, Cambridge, MA (US)

(21) Appl. No.: 12/481,973

(22) Filed: Jun. 10, 2009

Related U.S. Application Data
(63) Continuation of application No. 12/017,720, filed on Jan. 22, 2008, now Pat. No. 7,715,003.
Application No. 12/017,720 is a continuation-in-part of application No. 11/452,729, filed on Jun. 14, 2006, now Pat. No. 7,586,601.

(51) Int. Cl. G01J 3/44

(52) U.S. Cl. 356/301

(57) ABSTRACT

In one aspect, the present invention generally provides methods for fabricating substrates for use in a variety of analytical and/or diagnostic applications. Such a substrate can be generated by exposing a semiconductor surface (e.g., silicon surface) to a plurality of short laser pulses to generate micron-sized, and preferably submicron-sized, structures on the surface. The structured surface can then be coated with a thin metallic layer, e.g., one having a thickness in a range of about 10 nm to about 1000 nm.

### RELATED APPLICATION

This application claims priority to a provisional application entitled “Metalized Semiconductor Substrates for Raman Spectroscopy,” which was filed on Jan. 23, 2007 and has a Ser. No. 60/886,244.

This application is also a continuation-in-part (CIP) of U.S. patent application entitled “Applications of Laser-Processed Substrate for Molecular Diagnostics,” filed on Jun. 14, 2006 having a Ser. No. 11/452,729, which in turn claims priority to a provisional application filed on Jun. 14, 2005 and having a Ser. No. 60/690,385.

### BACKGROUND

The present invention relates generally to methods for fabricating substrates suitable for use in analytical and diagnostic optical systems, and in particular, substrates for use in Raman spectroscopy.

Raman spectroscopy can be employed as an analytical as well as a diagnostic technique in a variety of applications, such as material characterization and identification. It relies on inelastic scattering of incident photons by a molecule, via coupling to its vibrational modes, to provide an essentially unique signature for that molecule. In particular, such inelastic scattering (commonly known as Raman scattering) can cause a decrease or an increase in the scattered photon energy, which appear as “Stokes” and “anti-Stokes” peaks in a wavelength-dispersed spectrum of the scattered photons. A drawback of Raman spectroscopy is the relatively few incidences of such inelastic scattering. The probability that a scattering event will occur is typically called “cross-section,” which is expressed in terms of area.

Raman scattering cross-sections can, however, be significantly enhanced by placing the molecule on or near a conductive surface. Such a mode of performing Raman spectroscopy is commonly known as surface enhanced Raman spectroscopy (SERS). Although SERS is a promising technique for extending the use of Raman spectroscopy to a variety of new applications, its use is currently limited due to a dearth of reliable, high performance substrates.

Accordingly, there is a need for substrates for use in SERS, as well as other applications, that can provide a high degree of reliability and performance. There is also a need for methods of fabricating such substrates with a high degree of reproducibility, which can be easily and, preferably inexpensively, implemented.

### SUMMARY

In one aspect, a method of fabricating a substrate suitable for use in a variety of applications, such as surface enhanced Raman spectroscopy, is disclosed. The method includes generating micron-sized, and preferably submicron-sized structures, on a substrate surface, e.g., a semiconductor surface such as a silicon surface, by exposing the surface to a plurality of short laser pulses, e.g., sub-picosecond pulses (e.g., pulses having durations in a range of about 100 femtoseconds (10⁻¹⁵ seconds) to about one picosecond (10⁻¹² seconds)). In many cases, the pulses are applied to the surface while the surface is in contact with a liquid, e.g., polar or a non-polar liquid. Subsequently, the structured surface is coated with a thin metallic layer (e.g., a metallic layer having a thickness in a range of about 10 nm to about 1000 nm, and preferably in a range of about 50 nm to about 120 nm). In many cases, the metallic layer exhibits micron-sized, and preferably sub-micron-sized, structures that correspond substantially to the structures present in the underlying surface.

In another aspect, a diagnostic method is disclosed that includes generating a plurality of micron-sized and/or submicron-sized structures on a substrate surface, e.g., a semiconductor surface, by exposing the surface to a plurality of short laser pulses, followed by disposing a metallic layer, e.g., one having a thickness in a range of about 10 nm to about 1000 nm (and preferably in a range of about 50 nm to about 120 nm), over the structured surface. The metal-covered surface, which can exhibit structures corresponding substantially to the structures present on the underlying substrate surface, can then be utilized as a substrate for a diagnostic assay. In some cases, the diagnostic assay can comprise performing surface enhanced Raman spectroscopy.

In other aspect, a substrate for use in Raman spectroscopy, and other analytical and/or diagnostic applications, is disclosed that includes a substrate, e.g., a semiconductor substrate such as a silicon wafer, having a surface that exhibits micron-sized, and preferably submicron-sized, structures. A metallic layer having a thickness in a range of about 10 nm to about 1000 nm, and preferably in a range of about 50 nm to about 120 nm, covers at least a portion of the structured semiconductor surface. The metallic layer exhibits microns-sized, and preferably submicron-sized, structures (surface undulations). In many cases, the structured of the metallic layer correspond substantially to the structures present on the semiconductor surface.

Further understanding of the invention can be obtained by reference to the following detailed description in conjunction with the associated drawings, which are briefly described below.

### BRIEF DESCRIPTION OF THE DRAWINGS

FIG. 1 is a flow chart depicting various steps in some exemplary embodiments of methods of the invention for generating a metalized semiconductor sensing substrate,

FIG. 2 schematically depicts an exemplary apparatus suitable for generating micron-sized or submicron-sized structures on a substrates' surface, such as a semiconductor surface,

FIG. 3 shows nanosized structures, in the form of spikes, formed on a silicon surface by exposing the surface to a plurality of femtosecond pulses while the surface is in contact with water,

FIG. 4 schematically depicts a sensing substrate according to an embodiment of the invention, which includes a structured semiconductor surface coated with a thin metallic layer, and its use in SERS,

FIG. 5A is a surface enhanced Raman spectrum of a film of Benzenethiol disposed over a metal-covered structured silicon surface,

FIG. 5B is a control Raman spectrum of neat, bulk Benzenethiol,

### DETAILED DESCRIPTION

The present invention generally provides sensing substrates that are suitable for use in a variety of applications, including surface enhanced Raman spectroscopy (SERS). In some embodiments, a surface of a semiconductor substrate, e.g., silicon, is exposed to a plurality of short laser pulses (e.g., sub-picosecond laser pulses) to generate micron-sized, and preferably submicron-sized, structures (e.g., in the form of spikes) on that surface. The structured surface can then be coated with a thin layer of a metal, e.g., silver or gold, to be used as a substrate for SERS, or other applications. The term “structured surface,” as used herein, refers to a surface that exhibits undulations (e.g., spikes) with peak-to-trough excursions (e.g., amplitudes) of a few microns (e.g., less than about 20 microns), and preferably less than about 1 microns, and more preferably less than about 100 nanometer (e.g., in a range of about 1 nm to about 50 nm). The “structured surface” can exhibit a surface roughness with amplitudes less than about 1 micron, and preferably less than about 100 nanometers, and more preferably less than about 50 nm.

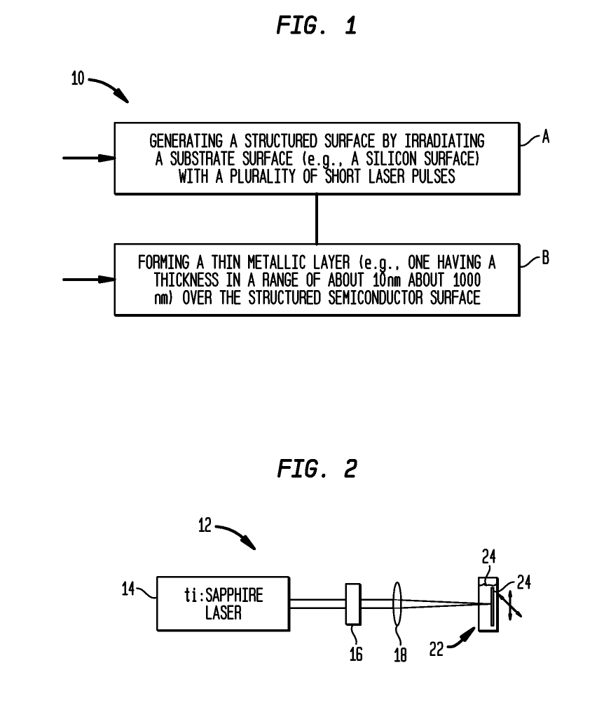

With reference to a flow chart 10 shown in FIG. 1, an exemplary method in accordance with one embodiment of the invention for fabricating a metalized sensing substrate, e.g., one suitable for use in surface enhanced Raman spectroscopy (SERS), comprises generating a structured surface (step A) by irradiating a substrate surface (e.g., a semiconductor surface, such as a silicon surface) with a plurality of short laser pulses. The term “short laser pulses,” as used herein, refers to laser pulses having durations less than about a few nanoseconds (10⁻⁹ seconds), e.g., pulses with durations in a range of about 100 femtoseconds (10⁻¹⁵ seconds) to about one picosecond (10⁻¹² seconds). By way of example, in some embodiments, a silicon substrate can be exposed to a plurality of short pulses (e.g., pulses having durations in a range of about 100 femtoseconds to about 500 femtoseconds) while the surface is in contact with a fluid, e.g., water. The pulses cause a change in surface topography characterized by surface undulations (e.g., surface roughness) having amplitudes less than about a few microns (e.g., less than about 10 microns), and preferably less than about 1 micron, e.g., in a range of about 50 nm to about 200 nanometers.

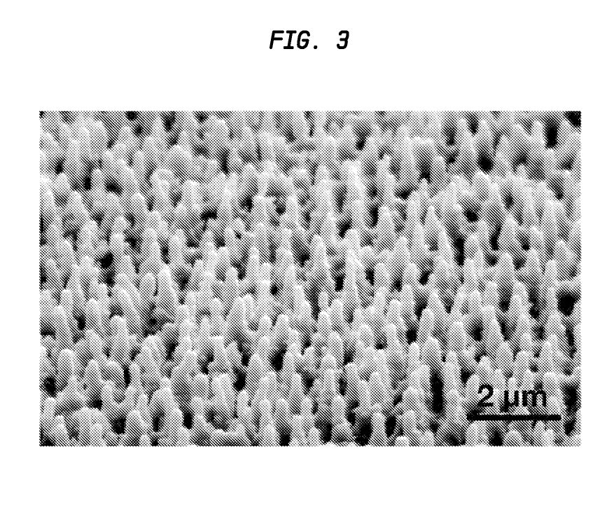

By way of example, FIG. 2 schematically depicts an exemplary optical system 12 suitable for processing a substrate (e.g., a semiconductor substrate) so as to generate micron-sized, and preferably submicron-sized, features (structures) on a surface thereof. For example, the features can include a plurality of spikes, e.g., substantially columnar structures extending from the surface to a height above the surface. The optical system 12 includes a Titanium-Sapphire (Ti:Sapphire) laser 14 for generating short laser pulses. By way of example, the Ti:Sapphire laser can generate laser pulses with a pulse width of about 80 femtoseconds at 800 nm wavelength (e.g., at an average power of 300 mW and at a repetition rate of 95 MHz). The pulses generated by the Ti:Sapphire laser can be applied to a chirped-pulse regenerative amplifier (not shown) that, in turn, can produce, e.g., 0.4 millijoule (mJ)), 100 femtosecond pulses at a wavelength of 800 nm and at a repetition rate of about 1 kilohertz.

The optical system 12 further includes a harmonic generation system 16 that receives the amplified pulses and doubles their frequency to produce, e.g., 100-femtosecond second-harmonic pulses at a wavelength of 400 nanometers. A lens 18 focuses the second-harmonic pulses onto a surface of a semiconductor sample 20, which can be disposed on a three-dimensional translation system (not shown). A glass liquid cell 22 can be coupled to the semiconductor sample so as to allow the sample surface exposed to the pulses to have contact with a liquid 24 (e.g., water) contained within the cell. Further details regarding methods and apparatuses for generating micron-sized, and preferably submicron-sized, features on a semiconductor surface can be found in co-pending U.S. patent application entitled “Femtosecond Laser-Induced Formation Of Submicrometer Spikes On A Semiconductor Substrate” having a Ser. No. 11/196,929, filed Aug. 4, 2005, which is herein incorporated by reference. U.S. Pat. No. 7,057,256 entitled “Silicon-Based Visible And Near-Infrared Optoelectronic Devices” and Published U.S. Patent Application No. 2003/00299495 entitled “Systems And Methods For Light Absorption and Field Emission Using Microstructured Silicon,” both of which are herein incorporated by reference, provide further disclosures regarding microstructuring silicon surfaces by application of short laser pulses.

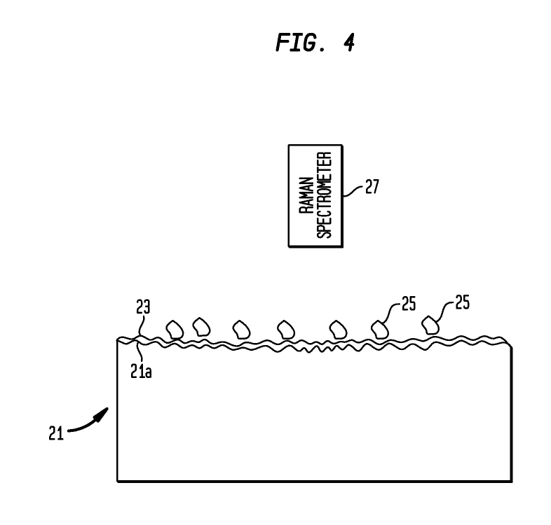

By way of illustration, FIG. 3 shows a silicon surface on which a plurality of nanosized features are generated via irradiation of the surface with a plurality of femtosecond laser pulses while the surface was in contact with water.

Referring again to the flow chart 10 of FIG. 1, in step (B), the structured semiconductor surface can be coated with a thin metallic layer, e.g., silver or gold, to generate a substrate for use in surface enhanced Raman spectroscopy (SERS), or other applications. The metallic layer exhibits a thickness in a range of about 10 nm to about 1000 nm, and more preferably in a range of about 50 nm to about 120 nm. In many embodiments, the metallic layer exhibits micron-sized, and preferably submicron-sized, features (structures) that substantially correspond to those of the underlying semiconductor surface. The metallic coating (e.g., a coating of Au, Ag, Pt, Rh, or other suitable metals) can be formed over the structured semiconductor surface, e.g., via evaporation, sputtering, electroplating or other suitable metal deposition methods. In this manner, a conductive surface exhibiting micron-sized, and preferably submicron-sized structures, can be formed that can be utilized in a variety of analytical and/or diagnostic applications, such as Raman spectroscopy.

The metal coating, which in many embodiments has a thickness comparable to, or smaller than, the wavelength of visible light, can provide an electric field enhancing conductive surface. Without being limited to any particular theory, the metal surface can exhibit surface plasmon resonance effects that can enhance electric fields in the vicinity of its mesostructures. Such enhancement of the electric field in the vicinity of the surface can advantageously be utilized in a variety of applications, such as Raman spectroscopy.

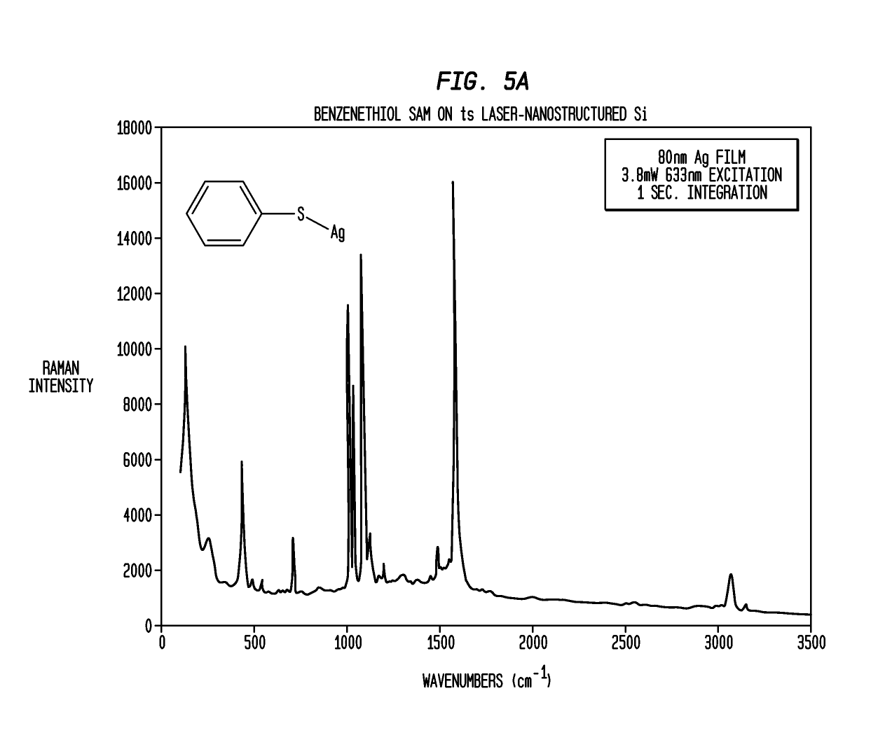

By way of example, FIG. 4 schematically depicts a silicon substrate 21 having a structured surface 21a (a surface exhibiting micron-sized or preferably submicron-sized structures) on which a thin metal layer 23 (e.g., a metal layer having a thickness in a range of about 10 nm to about 1000 nm, and preferably in a range of about 50 nm to about 120 nm) is deposited. The structured silicon surface can be formed in a manner discussed above (by exposure to short laser pulses), and the metal layer can be formed over the surface by any suitable method, such as evaporation and electrodeposition. In some embodiments, the metal-covered surface can be utilized as a sensing substrate for performing SERS. For example, an analyte of interest 25 can be disposed over the surface, or in proximity of the surface, and its Raman spectrum can be obtained by utilizing a Raman spectrometer 27. In other cases, the substrate surface can be placed within an environment so as to be in contact with, or in proximity of, one or more molecular species in that environment. The Raman spectra of those species can then be measured so as to obtain information about the environment, e.g., the presence and/or quantity of one or more analytes (molecular species).

The applications of the sensing substrates of the invention are not limited to those discussed above. For example, the metalized polymeric substrates of the invention can find a variety of uses in areas that require intense optical fields at a surface.

The following example provides further illustration of the salient aspects of the invention, and is provided only for illustrative purposes and to show the efficacy of the methods and systems according to the invention for significantly enhancing the signal-to-noise ratio in SERS. The example, however, does not necessarily show the optimal results (e.g., optimal signal-to-noise ratios) that can be obtained by employing the substrates of the invention.

### Example

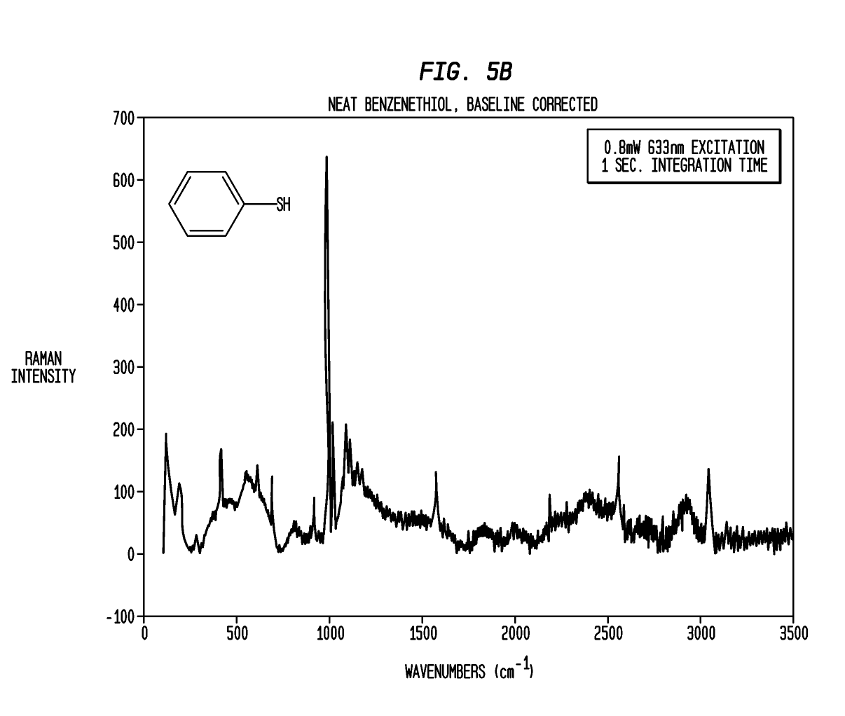

A silicon surface was irradiated with a plurality of femtosecond laser pulses with a pulse width of about 100 femtoseconds while the surface was in contact with water such that each surface location was exposed to about 500 laser pulses. In this manner, a plurality of submicron-sized features were formed on the silicon surface. A thin layer of silver with a thickness of about 80 nm was deposited over the nanostructured silicon surface. A film of Benzenethiol was disposed on the metal-covered surface and a Raman spectrum of the Benzenethiol was obtained by employing a commercial Raman spectrometer manufactured by Horiba Jobin Yvon, Inc. of New Jersey, U.S.A., under the trade designation Aramis. This Raman spectrum is shown in FIG. 5A. As a control, the Raman spectrum of bulk, neat Benzenethiol was obtained by employing the same spectrometer. The control spectrum is shown in FIG. 5B. A comparison of the spectra presented in FIGS. 5A and 5B indicates that the use of the metal-covered nanostructured silicon surface results in an enhancement of the order of 10¹⁰ in the signal-to-noise ratio of the Raman spectrum.

A self-assembled monolayer (SAM) of benzenethiol can be used to quantify the number of molecules present on the structured surfaces. The molecular packing density of benzenethiol on a silver surface is known to be approximately 4×10¹⁴ cm⁻². For the Raman spectra of the SAM on a silver coated structured semiconductor surface, the integrated peak intensity of a single Raman band can be normalized with a Raman band from the spectrum of a sample of neat benzenethiol so as to derive an enhancement factor of the scattering cross section per individual molecule. With knowledge of the neat sample's refractive index, molar volume, and probed volume, the EF of the various substrates can be determined. Utilizing this approach, in one set of experiments, an enhancement factor (EF) of about 1.88×10¹⁰ for the 1000 cm⁻¹ band, and an EF of about 1.49×10¹¹ for the 1572 cm⁻¹ band of Benzenethiol was obtained by utilizing a silver-coated structured silicon surfaces.

It should be understood that the enhancement factor can be defined differently than that discussed above, which can lead to different numerical values for the enhancement factor. Regardless, the above exemplary data shows that a significant enhancement factor can be achieved by the use of the metalized structured substrate. By way of example, an article entitled “Surface Enhanced Raman Scattering Enhancement Factors: A Comprehensive Study,” authored by Le Ru et al. and published in J. Phys. Chem. C 2007, 111, 13794-13803 describes various definitions of SERS enhancement factors. This article in herein incorporated by reference in its entirety

Those having ordinary skill in the art will appreciate that various modifications can be made to the above embodiments without departing from the scope of the invention.

1-12. (canceled)

13. A method for performing a diagnostic assay of an analyte, wherein the method comprises:
providing a base that has been structured using laser processing so as to provide at least one patterned surface,
wherein the laser processing comprises the selective application of pulsed laser energy to the base, whereby to melt a surface layer of the base which resolidifies, whereby to create the at least one patterned surface,
applying a metal to the at least one patterned surface so as to provide at least one metalized patterned surface, wherein the at least one metalized patterned surface has a surface profile configured to provide large electric fields when electromagnetic energy is delivered to the at least one metalized patterned surface,
positioning the analyte on the at least one metalized patterned surface, and
performing a diagnostic assay of the analyte by delivering electromagnetic energy to the analyte and/or the at least one metalized patterned surface.

14. A method according to claim 13 wherein the analyte comprises a fluid.

15. A method according to claim 14 wherein the fluid comprises a liquid.

16. A method according to claim 14 wherein the fluid comprises a gas.

17. A method according to claim 13 wherein the analyte comprises a solid.

18. A method according to claim 13 wherein the base comprises a semiconductor.

19. A method according to claim 18 wherein the base comprises silicon.

20. A method according to claim 13 wherein the base comprises a metal.

21. A method according to claim 13 wherein laser processing is effected using a femtosecond laser.

22. A method according to claim 13 wherein laser processing is effected by delivering laser light to the base at a selected pulse rate, fluence, angle and/or polarization.

23. A method according to claim 13 wherein the at least one patterned surface comprises high-aspect ratio structures.

24. A method according to claim 13 wherein the at least one patterned surface is configured to provide large electric fields when the analyte is disposed on the at least one metalized patterned surface and energy is delivered to the analyte and/or the at least one metalized patterned surface.

25. A method according to claim 13 wherein the at least one patterned surface comprises structures of a nanometer scale.

26. A method according to claim 13 wherein the at least one patterned surface comprises structures of a micrometer scale.

27. A method according to claim 13 wherein the at least one patterned surface comprises micron-scale spikes.

28. A method according to claim 27 wherein the micron-scale spikes are formed by laser processing a silicon base.

29. A method according to claim 13 wherein the at least one patterned surface comprises at least one of nanoscale bumps and nanoscale spikes.

30. A method according to claim 29 wherein the at least one of nanoscale bumps and nanoscale spikes are formed by laser processing a base covered with a liquid.

31. A method according to claim 13 wherein the at least one patterned surface comprises thin nanowires.

32. A method according to claim 31 wherein the thin nanowires are formed by laser processing a base covered with an organic solvent.

33. A method according to claim 13 wherein the base comprises at least two patterned surfaces.

34. A method according to claim 33 wherein the at least two patterned surfaces are spaced apart from one another.

35. A method according to claim 33 wherein the at least two patterned surfaces are spaced apart from one another.

36. A method according to claim 13 wherein the metal comprises a metal film.

37. A method according to claim 13 wherein the metal comprises silver or gold.

38. A method according to claim 13 wherein the metal is applied by physical vapor deposition.

39. A method according to claim 13 wherein the diagnostic assay comprises surface enhanced Raman spectroscopy, and further wherein the at least one metalized patterned surface provides the desired surface enhancement for the analyte.

40. A method according to claim 13 comprising the additional step of applying a coating to the at least one metalized patterned surface before performing the diagnostic assay.

41. A method according to claim 40 wherein the coating provides protection to the at least one metalized patterned surface.

42. A method according to claim 41 wherein the coating separates and/or fractionates the analyte.

43. A method according to claim 41 wherein the coating comprises a thin overcoat of glass.

44. A method according to claim 41 wherein the coating comprises a self-assembled monolayer (SAM).

45. A method according to claim 44 wherein the SAM functionalizes the at least one metalized patterned surface.

46. A method according to claim 45 wherein the SAM is configured so as to attract or repel a selected compound.

47. A method according to claim 41 wherein the coating comprises a thin paylene coating.

48. A method according to claim 13 comprising the additional step of applying a coating to the at least one metalized patterned surface to functionalize the surface before performing a diagnostic assay.

49. A method according to claim 40 comprising the additional step of applying a blocking layer to the at least one metalized patterned surface after applying the coating and before performing a diagnostic assay.

50. A method according to claim 1 comprising the additional step of modifying the least one metalized patterned surface so as to confine the analyte to the base before performing a diagnostic assay.

51. A method according to claim 50 wherein the step of modifying comprises roughening.

52. A method according to claim 50 wherein the step of modifying comprises patterning with a chemical treatment.

53. A method according to claim 13 further including the step of forming a via on the base.

54. A method according to claim 53 wherein the via is formed by laser ablation.

55. A method according to claim 53 wherein the via is formed by etching.

56. A method according to claim 53 wherein a cover is placed over the via.

57. A method according to claim 56 wherein the cover comprises polydimethylsiloxane.

58. A method according to claim 13 further including the step of forming at least one electrode on the base.

59. A method according to claim 13 further including the step of forming a pair of electrodes on the base.

60. A method according to claim 13 further including the step of applying a voltage across the base.

61. A method according to claim 13 further including the step of applying a voltage to the base so as to affect the disposition of the analyte relative to the at least one metalized patterned surface.
